(19) United States
(12) Patent Application Publication
(10) Pub. No.: US 2015/0227874 A1
(43) Pub. Date: Aug. 13, 2015

(54) Intervention Recommendation For Well Sites

(71) Applicant: WellAware Holdings, Inc., San Antonio, CA (US)

(72) Inventor: David John Lafferty, Katy, TX (US)

(21) Appl. No.: 14/621,125

(22) Filed: Feb. 12, 2015

Related U.S. Application Data
(60) Provisional application No. 61/938,876, filed on Feb. 12, 2014.

(51) Int. Cl. G06Q 10/06

(52) U.S. Cl. CPC G06Q 10/06313

(57) ABSTRACT

Implementations include actions of receiving a set of well-sites including one or more well-sites, receiving data associated with each well-site of the set of well-sites, receiving a set of intervention techniques, the set of intervention techniques including one or more intervention techniques, providing the data and the set of intervention techniques to an analytics engine, the analytics engine processing, for each well-site of the set of well-sites, respective data and intervention techniques to provide respective measure values for each intervention technique with respect to the well-site, providing the measure values to an optimization engine, the optimization engine processing the measure values to provide one or more optimized sets based on one or more parameters, and receiving the one or more optimized sets, each optimized set providing well-sites of the set of well-sites and one or more respective intervention techniques recommended for the respective well-site.

### CROSS-REFERENCE TO RELATED APPLICATIONS

This application claims priority to U.S. Provisional Application Ser. No. 61/938,876, filed on Feb. 12, 2014, which is expressly incorporated herein by reference.

### BACKGROUND

Well-site interventions occur in an effort to enhance production oil and/or gas production. Different intervention techniques have different costs associated therewith. Further, a particular intervention technique may have varying effectiveness depending on the particular well-site.

### SUMMARY

Implementations of the present disclosure include computer-implemented methods for recommending one or more intervention techniques for well-sites. In some implementations, actions include receiving a set of well-sites including one or more well-sites, receiving data associated with each well-site of the set of well-sites, receiving a set of intervention techniques, the set of intervention techniques including one or more intervention techniques, providing the data and the set of intervention techniques to an analytics engine, the analytics engine processing, for each well-site of the set of well-sites, respective data and intervention techniques to provide respective measure values for each intervention technique with respect to the well-site, providing the measure values to an optimization engine, the optimization engine processing the measure values to provide one or more optimized sets based on one or more parameters, and receiving the one or more optimized sets, each optimized set providing well-sites of the set of well-sites and one or more respective intervention techniques recommended for the respective well-site. Other implementations include corresponding systems, apparatus, and computer programs, configured to perform the actions of the methods, encoded on computer storage devices. These and other implementations can each optionally include one or more of features described in the present disclosure.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system that can be used in implementations of the present disclosure.

FIG. 2 depicts an example portion of a play network.

FIG. 3 depicts a representation of an example well-site.

FIG. 4 depicts an example process that can be executed in accordance with implementations of the present disclosure.

Like reference symbols in the various drawings indicate like elements.

### DETAILED DESCRIPTION

Implementations of the present disclosure are generally directed to recommending intervention techniques for well-sites. More specifically, implementations of the present disclosure are directed to receiving data associated with a well-site, processing the data in view of a set of intervention techniques to provide a measure of each intervention technique with respect to the well-site, and providing a set of well-sites for potential intervention based on respective sets of intervention techniques and respective measures. Example data includes pre-production data, production data and/or geostatistics. Example intervention techniques include workover, fracturing (refracturing), acidizing, installing artificial lift, enhancing artificial lift, and scale removal.

In some implementations, one or more analytical techniques are applied based on the data and the individual intervention techniques to provide a measure for the respective intervention technique. In some examples, the measure indicates a likelihood that the particular well-site will benefit from the respective intervention technique. In some implementations, one or more optimization techniques are applied based on measures and intervention techniques of a plurality of well-sites to provide the set of well-sites for potential intervention. In some examples, the set of well-sites for potential intervention includes a ranking of well-sites per intervention technique. In some examples, the set of well-sites for potential intervention is based on optimization of one or more parameters. Example parameters can include return-on-investment (ROI) and risk reduction.

Implementations of the present disclosure will be discussed in further detail with reference to an example context. The example context includes oil and gas well-sites. Within the example context, implementations of the present disclosure are discussed in further detail with reference to a production well-site located in a natural resource play. A natural resource play can be associated with oil and/or natural gas. In general, a natural resource play includes an extent of a petroleum-bearing formation, and/or activities associated with petroleum development in a region. An example geographical region can include southwestern Texas in the United States, and an example natural resource play includes the Eagle Ford Shale Play.

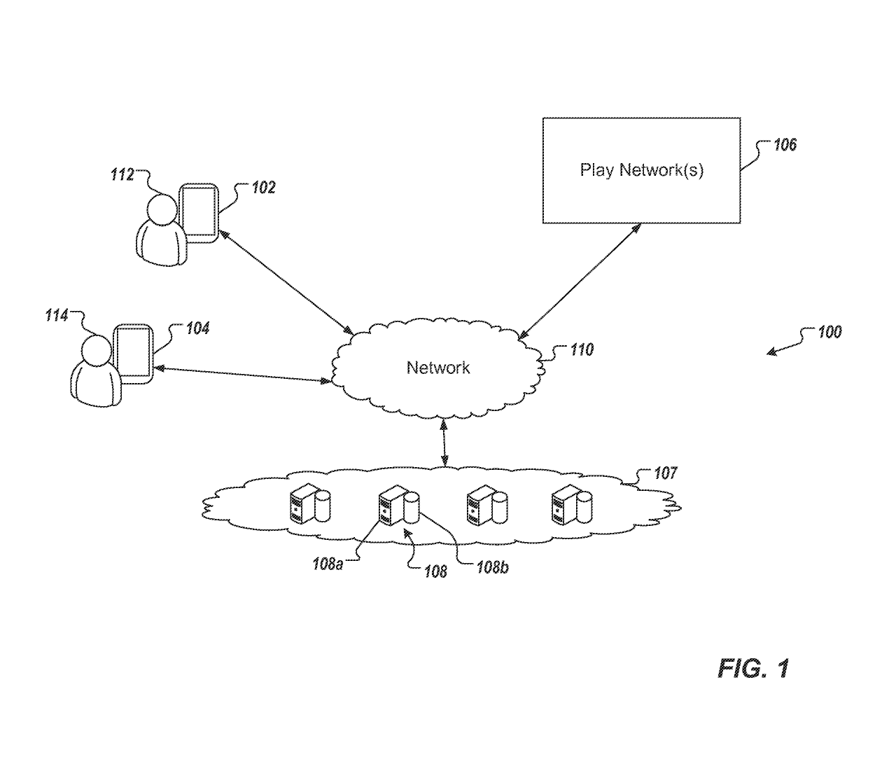

FIG. 1 depicts an example system 100 that can be used in implementations of the present disclosure. The example system 100 includes one or more computing devices, such as computing devices 102, 104, one or more play networks 106, and a computing cloud 107 that includes one or more computing systems 108. The example system 100 further includes a network 110. The network 110 can include a large computer network, such as a local area network (LAN), wide area network (WAN), the Internet, a cellular network, a satellite network, a mesh network, e.g., 900 Mhz, one or more wireless access points, or a combination thereof connecting any number of mobile clients, fixed clients, and servers. In some examples, the network 110 can be referred to as an upper-level network.

The computing devices 102, 104 are associated with respective users 112, 114. In some examples, the computing devices 102, 104 can each include various forms of a processing device including, but not limited to, a desktop computer, a laptop computer, a tablet computer, a wearable computer, a handheld computer, a personal digital assistant (PDA), a cellular telephone, a network appliance, a smart phone, an enhanced general packet radio service (EGPRS) mobile phone, or an appropriate combination of any two or more of these example data processing devices or other data processing devices. The computing systems 108 can each include a computing device 108a and computer-readable memory provided as a persistent storage device 108b, and can represent various forms of server systems including, but not limited to a web server, an application server, a proxy server, a network server, or a server farm.

In some implementations, and as discussed in further detail herein, site data (e.g., oil data and/or gas data) can be communicated from one or more of the play networks 106 to the computing systems 108 over the network 110. In some examples, each play network 106 can be provided as a regional network. For example, a play network can be associated with one or more plays within a geographical region. In some examples, each play network 106 includes one or more sub-networks. As discussed in further detail herein, example sub-networks can include a low power data sub-network, e.g., a low power machine-to-machine data network (also referred to as a smart data network and/or an intelligent data network, one or more wireless sub-networks, and mesh sub-networks, e.g., 900 Mhz.

In some examples, the computing systems 108 store the well data and/or process the well data to provide auxiliary data. In some examples, the well data and/or the auxiliary data are communicated over the play network(s) 106 and the network 110 to the computing devices 102, 104 for display thereon. In some examples, user input to the computing devices 102, 104 can be communicated to the computing systems 108 over the network 110.

In general, monitoring of well sites can include oil well monitoring and natural gas well monitoring (e.g., pressure(s), temperature(s), flow rate(s)), compressor monitoring (e.g., pressure, temperature), flow measurement (e.g., flow rate), custody transfer, tank level monitoring, hazardous gas detection, remote shut-in, water monitoring, cathodic protection sensing, asset tracking, water monitoring, access monitoring, and valve monitoring. In some examples, monitoring can include monitoring the presence and concentration of fluids (e.g., gases, liquids). In some examples, control capabilities can be provided, such as remote valve control, remote start/stop capabilities, remote access control.

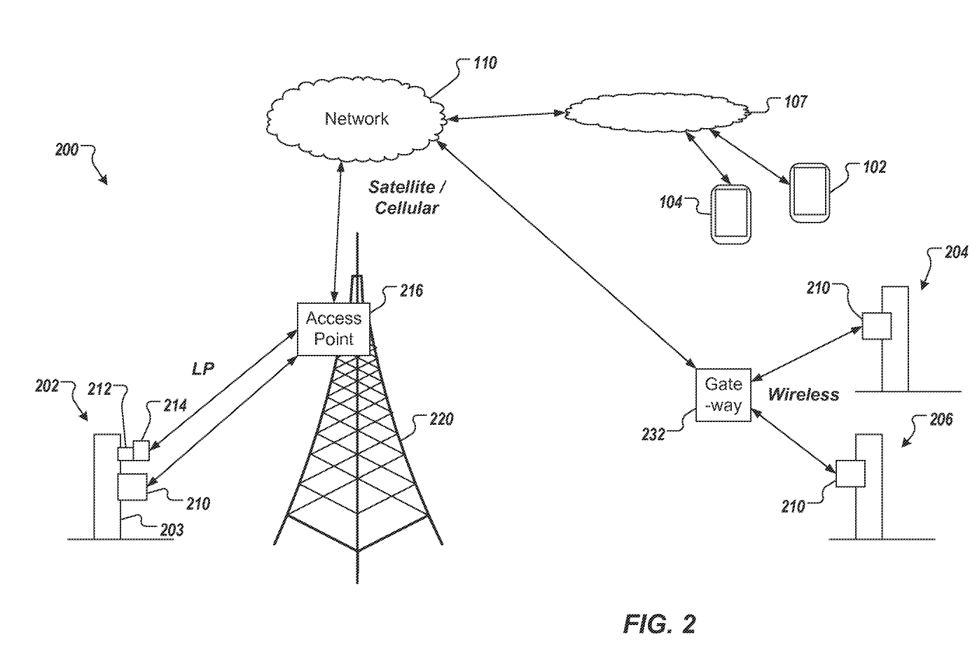

FIG. 2 depicts an example portion of an example play network 200. The example play network 200 provides low power (LP) communication, e.g., using a low power data network, and cellular and/or satellite communication for well data access and/or control. In some examples, as discussed herein, LP communication can be provided by a LP network. In the example of FIG. 2, a first well site 202, a second well site 204 and a third well site 206 are depicted. Although three well sites are depicted, it is appreciated that the example play network 200 can include any appropriate number of well sites. In the example of FIG. 2, well monitoring and data access for the well site 202 is provided using LP communication and cellular and/or satellite communication, and well monitoring and data access for the well sites 204, 206 is provided using cellular, satellite, and/or mesh network communication.

The example of FIG. 2 corresponds to the example context and sub-context (a production well-site) discussed above. It is appreciated, however, that implementations of the present disclosure. In the depicted example, the well site 202 includes a wellhead 203, a sensor system 210, a sensor system 212 and communication device 214. In some examples, the sensor system 210 includes a wireless communication device that is connected to one or more sensors, the one or more sensors monitoring parameters associated with operation of the wellhead 203. In some examples, the wireless communication device enables monitoring of discrete and analog signals directly from the connected sensors and/or other signaling devices. In some examples, the sensor system 210 can provide control functionality (e.g., valve control). Although a single sensor system 210 is depicted, it is contemplated that a well site can include any appropriate number of sensor systems 210. In some examples, the sensor system 212 includes one or more sensors that monitor parameters associated with operation of the wellhead 203. In some examples, the sensor system 212 generates data signals that are provided to the communication device 214, which can forward the data signals. Although a single sensor system 212 and communication device 214 are depicted, it is contemplated that a well site can include any appropriate number of sensor systems 212 and/or communication devices 214.

Well data and/or control commands can be provided to/from the well site 202 through an access point 216. More particularly, information can be transmitted between the access point 216, the sensor system 210, and/or the communication device 214 based on LP. In some examples, LP provides communication using a globally certified, license free spectrum (e.g., 2.4 GHz). In some examples, the access point 216 provides a radial coverage that enables the access point 216 to communicate with numerous well sites, such as the well site 202. In some examples, the access point 216 further communicates with the network 110 using cellular, satellite, mesh, point-to-point, point-to-multipoint radios, and/or terrestrial or wired communication.

In the depicted example, the access point 216 is mounted on a tower 220. In some examples, the tower 220 can include an existing telecommunications or other tower. In some examples, an existing tower can support multiple functionalities. In this manner, erection of a tower specific to one or more well sites is not required. In some examples, one or more dedicated towers could be erected.

In the depicted example, the well sites 204, 206 include respective wellheads 205, 207, and respective sensor systems 210 (discussed above). Although a single sensor system 210 is depicted for each well site 204, 206, it is contemplated that a well site can include any appropriate number of sensor systems 210. In some examples, well data and/or control commands can be provided to/from the well sites 202 through a gateway 232. More particularly, information can be transmitted between the gateway 232, and the sensor systems 210 can be wireless communication (e.g., radio frequency (RF)). In some examples, the gateway 232 further communicates with the network 110 using cellular and/or satellite communication.

In accordance with implementations of the present disclosure, well site control and/or data visualization and/or analysis functionality (e.g., hosted in the computing cloud 107 of FIGS. 1 and 2) and one or more play networks (e.g., the play networks 106, 200 of FIGS. 1 and 2) can be provided by a service provider. In some examples, the service provider provides end-to-end services for a plurality of well sites. In some examples, the service provider owns the one or more play networks and enables well site operators to use the play networks and control/visualization/monitoring functionality provided by the service provider. For example, a well site operator can operate a plurality of well sites. The well site operator can engage the service provider for well site control/visualization/monitoring services (e.g., subscribe for services). In some examples, the service provider and/or the well site operator can install appropriate sensor systems, communication devices and/or gateways (e.g., as discussed above with reference to FIG. 2). In some examples, sensor systems, communication devices and/or gateways can be provided as end-points that are unique to the well site operator.

In some implementations, the service provider can maintain one or more indices of end-points and well site operators. In some examples, the index can map data received from one or more end-points to computing devices associated with one or more well site operators. In some examples, well site operators can include internal server systems and/or computing devices that can receive well data and/or auxiliary data from the service provider. In some examples, the service provider can receive messages from well sites, the messages can include, for example, well data and an end-point identifier. In some examples, the service provider can route messages and/or auxiliary data generated by the server provider (e.g., analytical data) to the appropriate well site operator or personnel based on the end-point identifier and the index. Similarly, the service provider can route messages (e.g., control messages) from a well site operator to one or more appropriate well sites.

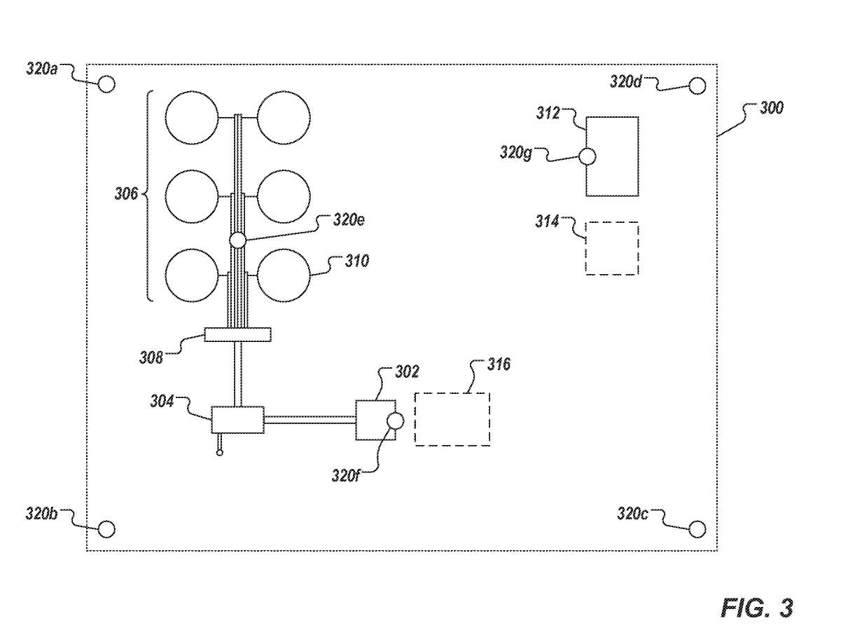

FIG. 3 depicts a representation of an example well-site 300. The example well-site 300 can include a production well-site, in accordance with the example sub-context provided above. In the depicted example, the well-site 300 includes a well-head 302, an oil and gas separator 304 and a storage tank system 306. In the depicted example, the storage tank system 306 includes a manifold 308 and a plurality of storage tanks 310. The example well-site 300 further includes a base station 312. In some examples, the well-site 300 can include a local weather station 314. In some examples, the well-site 300 can include artificial lift equipment 316, e.g., to assist in extraction of oil and/or gas from the well.

In some examples, the well-site 300 includes one or more sensors 320a-320g. In some examples, each sensor 320a-320g can be provided as a single sensor. In some examples, each sensor 320a-320g can be provided as a cluster of sensors, e.g., a plurality of sensors. Example sensors can include fluid sensors, e.g., gas sensors, temperature sensors, and/or pressure sensors. Each sensor 320a-320g is responsive to a condition, and can generate a respective signal based thereon. In some examples, the signals can be communicated through a network, as discussed above with reference to FIG. 2.

As introduced above, implementations of the present disclosure are directed to receiving data associated with a well-site, processing the data in view of a set of intervention techniques to provide a measure of each intervention technique with respect to the well-site, and providing a set of well-sites for potential intervention based on respective sets of intervention techniques and respective measures. Example data includes pre-production data, production data and/or geostatistics. It is contemplated that the data can include any appropriate data associated with the well-site. Example intervention techniques include workover, fracturing (refracturing), acidizing, installing artificial lift, enhancing artificial lift, and scale removal. It is contemplated that implementations of the present disclosure can include any appropriate intervention technique.

In some implementations, intervention techniques can include categories of techniques, and each category can include sub-categories. For example, artificial lift can be provided as a category of intervention technique, and example sub-categories can include pumping and gas-lift. In some examples, sub-categories can further include further sub-categories. For example, pumping can include rod pumping, electrical submersible pumping (ESP), progressive capacity pumping (PCP), and hydraulic pumping.

In some implementations, one or more analytical techniques are applied based on the data and the individual intervention techniques to provide a measure for the respective intervention technique. In some examples, measures can be provided for a category and/or sub-categories. In some examples, a measure for a category is provided based on one or more measures of corresponding sub-categories. In some examples, the measure for the category is provided as a maximum of the measures of the sub-categories (e.g., the category measure is set equal to the sub-category measure having the highest value). In some examples, the measure for the category is provided as a minimum of the measures of the sub-categories (e.g., the category measure is set equal to the sub-category measure having the lowest value). In some examples, the measure for the category is provided as an average of the measures of the sub-categories.

In some examples, the measure indicates a likelihood that the particular well-site will benefit from the respective intervention technique (e.g., category or sub-category). In some implementations, each measure can range between a minimum value and a maximum value. An example minimum value can be zero (0). An example maximum value can be one (1). In some examples, the minimum value indicates that there is little to no likelihood that the particular well-site would benefit from the particular intervention technique. In some examples, the maximum likelihood indicates that there is a level of certainty that the particular well-site would benefit from the particular intervention technique.

In some implementations, one or more optimization techniques are applied based on measures and intervention techniques of a plurality of well-sites to provide the set of well-sites for potential intervention. In some examples, the set of well-sites for potential intervention includes a ranking of well-sites per intervention technique.

In some implementations, the set of well-sites for potential intervention is based on optimization of one or more parameters. Example parameters can include return-on-investment (ROI) and risk reduction. It is contemplated, however, that implementations of the present disclosure can incorporate any appropriate parameter. In some examples, optimization is performed to minimize a parameter. For example, optimization can be performed to minimize a risk value associated with the set of well-sites. In some examples, optimization is performed to maximize a parameter. For example, optimization can be performed to maximize a ROI value associated with the set of well-sites. In some examples, optimization is performed to minimize one parameter and maximize another parameter. For example, optimization can be performed to minimize a risk value associated with the set of well-sites, and maximize a ROI value associated with the set of well-sites.

In some implementations, the one or more parameters can be associated with respective target values, and optimization can be performed to achieve the target value(s). For example, a target ROI can be provided (e.g., by an operator of the well-sites). In some examples, the target ROI includes a minimum acceptable ROI. As another example, a target risk value can be provided (e.g., by an operator of the well-sites). In some examples, the target risk value includes a maximum acceptable risk value.

In accordance with implementations of the present disclosure, a super-set of well-sites can be provided. In some examples, the super-set of well-sites includes one or more well-sites associated with a particular region (e.g., a particular natural resource play or a portion thereof). In some examples, the super-set of well-sites includes one or more well-sites associated with a particular well-site operator. In some examples, a well-site operator can operate a plurality of well-sites within one or more regions. An example super-set of well-sites can include well-sites WS₁, . . . WSₙ. In some implementations, the super-set of well-sites is filtered to provide a set of well-sites (e.g., a sub-set of the super-set). An example sub-set of well-sites can include well-sites WS_{q}, . . . , WSᵣ, wherein 1≦q≦r≦n.

In some examples, the super-set of well-sites is filtered based on one or more site parameters. In some examples, the one or more site parameters can indicate the efficiency, productivity and/or safety of a particular well-site. In some examples, the one or more site parameters can provide an initial indication of whether a particular well-site is a candidate for intervention. For example, a well-site that is producing at expected levels and/or has no indication of a safety issue can be filtered from the super-set of well-sites (i.e., is not included in the sub-set of well-sites). As another example, a well-site that is not producing at expected levels and/or has a safety concern is not filtered from the super-set of well-sites (i.e., is included in the sub-set of well-sites). In some examples, filtering results in no well-sites being filtered from the super-set of well-sites. Consequently, the super-set of well-sites and the sub-set of well-sites are the same.

In accordance with implementations of the present disclosure, data associated with each of the well-sites in the sub-set of well-sites WS_{q}, . . . , WSᵣ is received. In some examples, data can be received from one or more data sources. For example, data can be received from a database of the operator(s) of the well-sites in the sub-set of well-sites. As another example, data can be received from a database of the service provider providing well site control and/or data visualization and/or analysis functionality, discussed above with reference to FIGS. 1-3. As another example, data can be received from a database of a third-party.

As introduced above, example data includes pre-production data, production data and/or geostatistics. In some examples, pre-production data can be generally described as static data (e.g., data provided before production began at the well-site). Example pre-production data includes formation type (e.g., shale, sand, rock), formation depth, bore depth, stimulation (e.g., hydraulic fracturing (sand fracturing, pellet fracturing), matrix acidizing), completion data (e.g., completion type (multi-layer, very slanted, TFL, dogleg)). Although example pre-production data is provided herein, it is contemplated that the data can include any appropriate pre-production data. In some examples, production data can be provided from the operator and/or other entities. In some examples, production data can be generally described as dynamic data (e.g., data provided after production begins at the well-site). Example production data includes production volumes (e.g., oil and/or gas), production rates, interventions (e.g., type, date), and measured parameters (e.g., temperatures, pressures, flowrates). In some examples, measured parameters are provided based on signals received from one or more sensors (e.g., the sensors 320a-320g of FIG. 3). In some examples, geostatistics can provide data related to reservoir characterization, and volumetrics and uncertainty assessment.

In some examples, the pre-production data is received from the well-site operator, and/or any entity (e.g., contractor) that was involved in pre-production activity at the well-site (e.g., drilling, completion). In some examples, production data is received from the well-site operator and/or a service provider (e.g., the service provider providing well site control and/or data visualization and/or analysis functionality, discussed above with reference to FIGS. 1-3). In some examples, geostatistic data can be by one or more third-party providers.

In some implementations, a set of intervention techniques can be provided and can be processed based on the data. In some examples, the one or more analytical techniques can qualify or disqualify particular intervention techniques (e.g., categories and/or sub-categories) for each well-site of the sub-set of well-sites based on the data to provide a sub-set of intervention techniques. That is, for a particular well-site, a particular intervention can be filtered from the set of intervention techniques and/or assigned a minimum measure value (e.g., 0) to provide a sub-set of intervention techniques for that well-site. For example, for a particular type of well-site and/or formation, a particular intervention technique cannot be used. Consequently, the particular intervention technique is not included in the sub-set of intervention techniques. In some examples, filtering can be provided based on a set of filtering rules, each filtering rule defining whether a particular intervention technique is applicable based on a respective well-site. With regard to artificial lift, an example filtering rule can be provided as:
IF completion_type=TFL THEN:
   ROD_PUMP=UNACCEPTABLE
   GAS_LIFT=ACCEPTABLE
   ESP=UNACCEPTABLE
   PCP=UNACCEPTABLE
   HYDR_PISTON_PUMP=UNACCEPTABLE
   HYDR_JET_PUMP=ACCEPTABLE

In accordance with the example filtering rule, because the well-site being considered has a through flow line (TFL) completion, gas lift and hydraulic jet pump are provided as acceptable options for artificial lift, while rod pump, ESP, PCP and hydraulic piston pump are provided as unacceptable options for artificial. Consequently, rod pump, ESP, PCP and hydraulic piston pump can be filtered from the set of intervention techniques for the particular well-site, and/or the respective measures associated with each can be set to a minimum value (e.g., 0).

In some implementations, the intervention techniques included in the sub-set of intervention techniques and/or intervention techniques that have not already been assigned a measure value (e.g., the minimum value) can be processed based on the data to provide respective measures. More particularly, the sub-set of intervention techniques and the data can be provided as input to an analytics engine that processes the intervention techniques in view of the data to assign a measure value to each intervention technique (e.g., category and/or sub-category). In some examples, the analytics engine is provided as one or more computer-executable programs executed by one or more computing devices. In some examples, the analytics engine provides measures for each of the intervention techniques for each well-site. For example, the analytics engine can provide a matrix that provides measures based on intervention technique and well-set. An example matrix can be provided as:

| | |
|---|---|
| Stimuation | Artificial Lift |

| | Hydr. | Mat. | Rod | | | |
|---|---|---|---|---|---|---|
| Well | Frac. | Acid. | Pump | Gas | ESP | . . . |
| WS_{q} | 0 | 0 | 0.25 | 0.75 | 0.5 | . . . |
| . . . | . . . | . . . | . . . | . . . | . . . | . . . |
| WSᵣ | 0.6 | 0 | 0 | 1 | 0.75 | . . . |

In some examples, and as discussed above, measures can be provided for a category and/or sub-category of intervention technique. In the example matrix provided above, measures are provided for each sub-category.

In accordance with implementations of the present disclosure, the measures and data can be provided as input to an optimization engine. In some implementations, cost data and safety data can be provided. In some examples, the cost data indicates costs associated with respective intervention techniques (e.g., costs required to perform the intervention technique). In some examples, the cost data can include monetary cost and temporal cost. In some examples, safety data indicates safety values associated with respective intervention techniques. In some implementations, result data can be provided. Example result data can include improvements in oil and/or gas production that result from a respective intervention. In this manner, calculations can be made as to increase in income based on increase in production resulting from respective intervention techniques.

In some examples, the optimization engine processes the measures and data to optimize one or more parameters associated with the well-sites. In some examples, parameter optimization includes optimizing parameters associated with respective well-sites in the sub-set of well-sites, and/or optimizing parameters across all well-sites in the sub-set of well-sites. In some examples, optimization is performed to minimize a parameter. For example, optimization can be performed to minimize a risk value associated with the individual well-sites of the sub-set of well-sites, or an overall risk value across all well-sites of the sub-set of well-sites. In some examples, optimization is performed to maximize a parameter. For example, optimization can be performed to maximize a ROI value associated with individual well-sites of the sub-set of well-sites, or an overall ROI across all well-sites of the sub-set of well-sites. In some examples, optimization is performed to minimize one parameter and maximize another parameter. For example, optimization can be performed to minimize a risk value associated with the well-sites of the sub-set of well-sites, and maximize a ROI value associated with well-sites of the sub-set of well-sites.

In some implementations, the one or more parameters can be associated with respective target values, and optimization can be performed to achieve the target value(s). For example, a target ROI can be provided (e.g., by an operator of the well-sites). In some examples, the target ROI includes a minimum acceptable ROI. As another example, a target risk value can be provided (e.g., by an operator of the well-sites). In some examples, the target risk value includes a maximum acceptable risk value.

In accordance with implementations of the present disclosure, the optimization engine provides a set of well-sites and respective intervention techniques that result in optimization of the one or more parameters. In some examples, the optimization engine provides a plurality of sets, each set corresponding to a respective parameter and/or plurality of parameters. For example, the optimization engine can provide a set that is associated with optimization of a safety value. As another example, the optimization engine can provide a set that is associated with optimization of a ROI value. As another example, the optimization engine can provide a set that is associated with optimization of the safety value and the ROI value.

In some implementations, the set of well-sites provides one or more recommended intervention techniques for one or more well-sites of the sub-set of well-sites for achieving optimization of the respective parameter(s). In some examples, although a particular well-site could benefit from an intervention technique, an intervention technique is not recommended for the particular well-site, because it would not contribute to optimization of the parameter(s). Consequently, and in some example, the set can indicate that no intervention technique is recommended for certain well-sites, as part of optimizing the parameter(s).

In some examples, the one or more sets are provided to the operator of the well-sites of the sub-set of well-sites. In this manner, the operator can plan well-site intervention(s) based on the set(s).

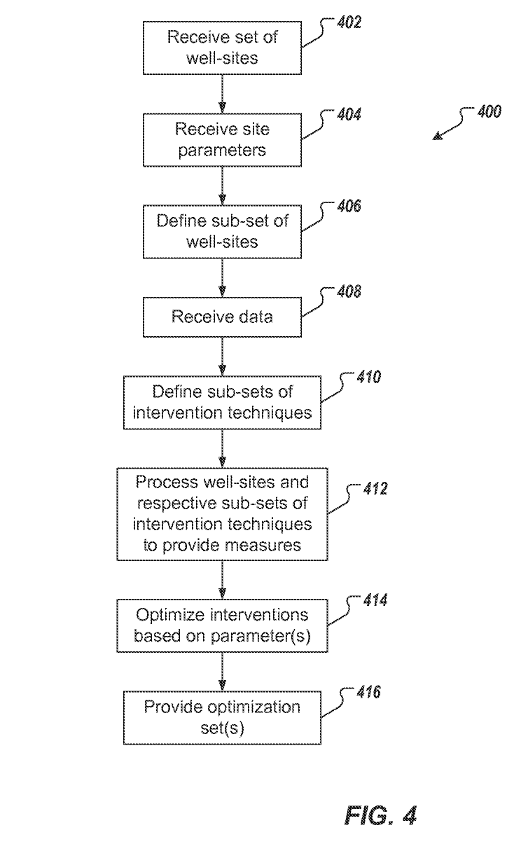

FIG. 4 depicts an example process 400 that can be executed in accordance with implementations of the present disclosure. In some examples, the example process 400 can be provided as one or more computer-executable programs executed using one or more computing devices. In some examples, the example process 400 can be executed by the computing cloud 107 of FIG. 1.

A set of well-sites is received (402). In some examples, the set of well-sites is provided as the super-set of well-sites discussed herein. In some examples, well-sites of the set of well-sites are associated with a region and/or operator. In some examples, well-sites of the set of well-sites are to be considered for intervention recommendation. In some examples, the set of well-sites includes a unique identifier associated with each well-site. Site parameters are received (404). In some examples, the site parameters are associated with well-sites of the set of well-sites. In some examples, the site parameters are received based on the unique identifiers (e.g., a request is made to one or more databases based on the unique identifiers).

A sub-set of well-sites is defined (406). In some examples, the sub-set of well-sites includes well-sites of the super-set of well-sites. In some examples, well-sites of the super-set of well-sites can be filtered based on one or more site parameters to provide the sub-set of well-sites. Data is received (408). In some examples, data associated with each well-site of the sub-set of well-sites is received. In some examples, the data received based on the unique identifiers (e.g., a request is made to one or more databases based on the unique identifiers). In some examples, the data includes pre-production data, production data, and/or geostatistics.

Sub-sets of intervention techniques are defined (410). In some examples, a sub-set of intervention techniques is provided for each well-site in the sub-set of well-sites. In some examples, each sub-set of intervention techniques includes intervention techniques that are applicable to a respective well-site, and/or a minimum measure value associated with intervention techniques that are not applicable to the respective well-site. Well-sites of the sub-set of well-sites and respective sub-sets of intervention techniques are processed to provide measures (414). In some examples, the sub-set of well-sites, the sub-sets of intervention techniques, and/or the data are provided to an analytics engine, which performs processing and provides the measures. Intervention techniques of the sub-sets of intervention techniques are optimized based on one or more parameters (414). In some examples, the sub-set of well-sites, the sub-sets of intervention techniques, the measures, and/or the data are provided to an optimization engine, which performs processing. One or more optimized sets of well-sites are provided (416). In some examples, the one or more optimized sets of well-sites are provided from the optimization engine.

Implementations of the subject matter and the operations described in this specification can be realized in digital electronic circuitry, or in computer software, firmware, or hardware, including the structures disclosed in this specification and their structural equivalents, or in any appropriate combinations thereof. Implementations of the subject matter described in this specification can be realized using one or more computer programs, i.e., one or more modules of computer program instructions, encoded on computer storage medium for execution by, or to control the operation of, data processing apparatus, e.g., one or more processors. In some examples, program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. In some examples, the data processing apparatus can include special purpose logic circuitry, e.g., an FPGA (field programmable gate array) or an ASIC (application specific integrated circuit). In some examples, the data processing apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a mesh network, a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for recommending intervention techniques for well-sites, the method being executed using one or more processors and comprising:
receiving, by the one or more processors, a set of well-sites comprising one or more well-sites;
receiving, by the one or more processors, data associated with each well-site of the set of well-sites;
receiving, by the one or more processors, a set of intervention techniques, the set of intervention techniques comprising one or more intervention techniques;
providing, by the one or more processors, the data and the set of intervention techniques to an analytics engine, the analytics engine processing, for each well-site of the set of well-sites, respective data and intervention techniques to provide respective measure values for each intervention technique with respect to the well-site;
providing, by the one or more processors, the measure values to an optimization engine, the optimization engine processing the measure values to provide one or more optimized sets based on one or more parameters; and
receiving, by the one or more processors, the one or more optimized sets, each optimized set providing well-sites of the set of well-sites and one or more respective intervention techniques recommended for the respective well-site.

2. The method of claim 1, wherein each measure value indicates a likelihood that a respective well-site will benefit from a respective intervention technique.

3. The method of claim 1, further comprising receiving at least one of cost data and safety data, the cost data indicating costs associated with respective intervention techniques and comprising at least one of monetary cost and temporal cost, wherein the optimization further processes the at least one of cost data and safety data.

4. The method of claim 1, wherein data is received from one or more of a database of operators of the well-sites in the set of well-sites, a database of a service provider providing well site control and/or data visualization and/or analysis functionality of one or more well-sites in the set of well-sites, and a database of a third-party.

5. The method of claim 1, wherein the optimization engine optimizes the set of well-sites for potential intervention based on one or more of return-on-investment (ROI) and risk reduction associated with respective well-sites.

6. The method of claim 1, wherein data associated with each well-site of the set of well-sites comprises one or more of pre-production data, production data, and geostatistics.

7. The method of claim 1, wherein intervention techniques comprise one or more of workover, fracturing, refracturing, acidizing, installing artificial lift, enhancing artificial lift, and scale removal.

8. A non-transitory computer-readable storage medium coupled to one or more processors and having instructions stored thereon which, when executed by the one or more processors, cause the one or more processors to perform operations for recommending intervention techniques for well-sites at a facility, operations comprising:
receiving a set of well-sites comprising one or more well-sites;
receiving data associated with each well-site of the set of well-sites;
receiving a set of intervention techniques, the set of intervention techniques comprising one or more intervention techniques;
providing the data and the set of intervention techniques to an analytics engine, the analytics engine processing, for each well-site of the set of well-sites, respective data and intervention techniques to provide respective measure values for each intervention technique with respect to the well-site;
providing the measure values to an optimization engine, the optimization engine processing the measure values to provide one or more optimized sets based on one or more parameters; and
receiving the one or more optimized sets, each optimized set providing well-sites of the set of well-sites and one or more respective intervention techniques recommended for the respective well-site.

9. The computer-readable storage medium of claim 8, wherein each measure value indicates a likelihood that a respective well-site will benefit from a respective intervention technique.

10. The computer-readable storage medium of claim 8, wherein operations further comprise receiving at least one of cost data and safety data, the cost data indicating costs associated with respective intervention techniques and comprising at least one of monetary cost and temporal cost, wherein the optimization further processes the at least one of cost data and safety data.

11. The computer-readable storage medium of claim 8, wherein data is received from one or more of a database of operators of the well-sites in the set of well-sites, a database of a service provider providing well site control and/or data visualization and/or analysis functionality of one or more well-sites in the set of well-sites, and a database of a third-party.

12. The computer-readable storage medium of claim 8, wherein the optimization engine optimizes the set of well-sites for potential intervention based on one or more of return-on-investment (ROI) and risk reduction associated with respective well-sites.

13. The computer-readable storage medium of claim 8, wherein data associated with each well-site of the set of well-sites comprises one or more of pre-production data, production data, and geostatistics.

14. The computer-readable storage medium of claim 8, wherein intervention techniques comprise one or more of workover, fracturing, refracturing, acidizing, installing artificial lift, enhancing artificial lift, and scale removal.

15. A system, comprising:
a computing device; and
a computer-readable storage device coupled to the computing device and having instructions stored thereon which, when executed by the computing device, cause the computing device to perform operations for recommending intervention techniques for well-sites at a facility, operations comprising:
receiving a set of well-sites comprising one or more well-sites;
receiving data associated with each well-site of the set of well-sites;
receiving a set of intervention techniques, the set of intervention techniques comprising one or more intervention techniques;
providing the data and the set of intervention techniques to an analytics engine, the analytics engine processing, for each well-site of the set of well-sites, respective data and intervention techniques to provide respective measure values for each intervention technique with respect to the well-site;
providing the measure values to an optimization engine, the optimization engine processing the measure values to provide one or more optimized sets based on one or more parameters; and
receiving the one or more optimized sets, each optimized set providing well-sites of the set of well-sites and one or more respective intervention techniques recommended for the respective well-site.

16. The system of claim 15, wherein each measure value indicates a likelihood that a respective well-site will benefit from a respective intervention technique.

17. The system of claim 15, wherein operations further comprise receiving at least one of cost data and safety data, the cost data indicating costs associated with respective intervention techniques and comprising at least one of monetary cost and temporal cost, wherein the optimization further processes the at least one of cost data and safety data.

18. The system of claim 15, wherein data is received from one or more of a database of operators of the well-sites in the set of well-sites, a database of a service provider providing well site control and/or data visualization and/or analysis functionality of one or more well-sites in the set of well-sites, and a database of a third-party.

19. The system of claim 15, wherein the optimization engine optimizes the set of well-sites for potential intervention based on one or more of return-on-investment (ROI) and risk reduction associated with respective well-sites.

20. The system of claim 15, wherein data associated with each well-site of the set of well-sites comprises one or more of pre-production data, production data, and geostatistics.
